(19) United States
(12) Patent Application Publication
(10) Pub. No.: US 2021/0271356 A1
(43) Pub. Date: Sep. 2, 2021

(54) PERSONALIZED USER EXPERIENCE USING FACIAL RECOGNITION

(71) Applicant: NEC Laboratories America, Inc., Princeton, NJ (US)

(72) Inventors: Biplob Debnath, Princeton, NJ (US); Murugan Sankaradas, Dayton, NJ (US); Srimat Chakradhar, Manalapan, NJ (US)

(21) Appl. No.: 17/187,092

(22) Filed: Feb. 26, 2021

Related U.S. Application Data
(60) Provisional application No. 62/983,888, filed on Mar. 2, 2020.

(51) Int. Cl. G06F 3/0484; G06K 9/00; H04L 29/08

(52) U.S. Cl. CPC G06F 3/0484; H04L 67/306; G06K 9/00711; G06K 9/00288

(57) ABSTRACT

Methods and systems for controlling a user interface include identifying a user at a station based on facial recognition of an image of the user's face in a video stream, to match a profile for the user. At least one preference of the user is determined for the display of content, based on the matched profile. Content for the user is configured in accordance with the at least one preference. The configured content is displayed on a user interface of the station.

### RELATED APPLICATION INFORMATION

This application claims priority to U.S. patent application Ser. No. 62/983,888, filed on Mar. 2, 2020, incorporated by reference herein in its entirety.

### BACKGROUND

### Technical Field

The present invention relates to user experience management, and, more particularly, to the use of facial recognition to enhance a user's experience.

### Description of the Related Art

Facial recognition technology is becoming increasingly common, with video cameras being deployed widely and in many different contexts. This provides a wealth of information about user activities.

### SUMMARY

A method for controlling a user interface includes identifying a user at a station based on facial recognition of an image of the user's face in a video stream, to match a profile for the user. At least one preference of the user is determined for the display of content, based on the matched profile. Content for the user is configured in accordance with the at least one preference. The configured content is displayed on a user interface of the station.

A system for controlling a user interface includes a user interface, a hardware processor, and a memory that stores a computer program product. When the computer program product is executed by the hardware processor, it causes the hardware processor to identify a user at a station based on facial recognition of an image of the user's face in a video stream, to match a profile for the user, to determine at least one preference of the user for the display of content, based on the matched profile, to configure content for the user in accordance with the at least one preference, and to display the configured content on the user interface.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an environment where individuals may interact with one or more stations, and where video cameras provide identifying information that help to personalize the content of the one or more stations, in accordance with an embodiment of the present invention;

FIG. 2 is a block/flow diagram of a method for identifying a user and personalizing a user interface in accordance with the identification, in accordance with an embodiment of the present invention;

FIG. 3 is a block/flow diagram of a method for matching an image of a user's face to a profile, in accordance with an embodiment of the present invention;

FIG. 4 is a block diagram of a user experience management system that uses video information to personalize the user experience of one or more stations, in accordance with an embodiment of the present invention;

FIG. 5 is a block diagram of a user experience manager, in accordance with an embodiment of the present invention that controls the user interface of one or more stations, in accordance with an embodiment of the present invention; and

FIG. 6 is a block diagram of a user interface station that receives user interface control personalization information, in accordance with an embodiment of the present invention.

### DETAILED DESCRIPTION OF PREFERRED EMBODIMENTS

Facial recognition may be used to enhance and personalize a user's experience, as it can be used to identify a person's activities and associate those activities with a record of the user's preferences and other information. For example, as a user passes by the exhibits of a museum, the user's position and attention can be tracked using video cameras and facial recognition. Once the visitor's identity is confirmed at a particular exhibit, the exhibit can customize its service to provide a personalized experience.

For example, the personalized experience may include altering the exhibit's content and presentation in a manner that matches the user's preferences. This can help users with disabilities, such as blindness, color blindness, and partial or complete deafness, to access the exhibits. For example, if a person with color blindness approaches the exhibit, the exhibit may change its presentation to use only colors that the visitor can easily distinguish. If a user with partial deafness approaches the exhibit, the exhibit may change its auditory components to focus on frequencies that the visitor can hear, or can automatically enable hearing assistance technologies.

The personalized experience can also include matching a user's aesthetic and informational preferences. For example, a user may indicate in a profile that they are particularly interested in particular kinds of information, and the exhibit may automatically provide such information. The user may also customize the appearance of any exhibit interface, for example by selecting design elements such as color palate, theme, font, etc.

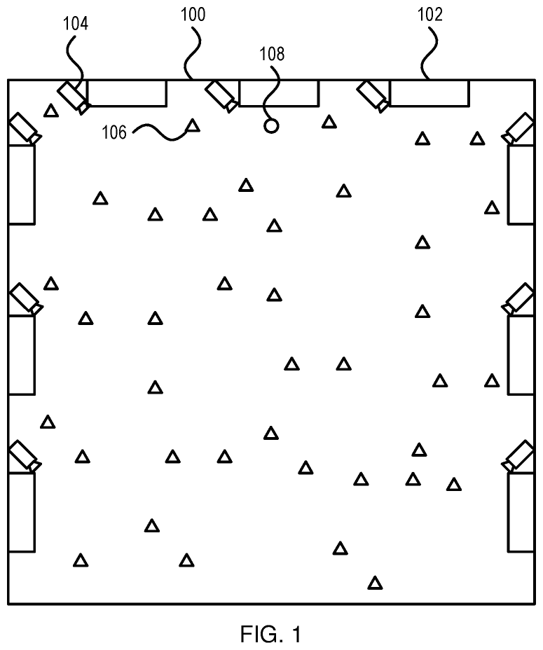

Referring now to FIG. 1, an exemplary environment 100 is shown. The environment may include one or more stations 102. These stations 102 will each have a function, for example in displaying information or media, in accepting inputs from a user, or providing an interactive or passive experience to the user. One or more individuals 106 may move within the environment 100, and may approach the stations 102 to view them or to interact with them. Such an environment may be, for example, a museum, a gaming facility, a casino, a control room, or any other place where individuals may approach a station for an intended function.

Cameras 104 may be positioned within the environment 100 to capture images of users' faces. In some cases, these cameras 104 may be video cameras that capture a series of images. In other cases, the cameras 104 may take still photos, for example being triggered periodically or upon the approach of a user to a station 102. In some cases, each station 102 may have one or more dedicated cameras 104 to monitor users' interactions with the station. In other cases, cameras 104 may be distributed throughout the environment, or positioned in key areas within the environment, to track user motion generally. For example, the cameras 104 may be part of a security system, and the images of users' faces may be used for the purpose of facial recognition and identification.

Each station 102 and camera 104 may be assigned a respective identifier. By associating a camera identifier and an exhibit identifier, the location of visitors 106 in the field of view of a camera 104, and particularly the location of visitors 106 with respect to the stations 102, can be readily determined.

As a person 108 approaches a station 102, a camera 104 may take a person of the person's face. The identity of the person may be found using facial recognition, and the use of the station 102 may be customized to the user's preferences and needs. For example, the station 102 may automatically adapt its display and content to the user's stated interests, language, and physical abilities.

Additionally, if multiple people 108 are interacting with the station 102, each of them may be identified in this fashion. The station 102 may provide information that reflects a combination of their preferences, for example by providing a split-screen view or by otherwise providing information that is tailored to each individual.

In the event that the station 102 is used to accept inputs from the user, the controls may be adapted to the user's preferences and abilities. For example, if the user 108 has a job that calls for particular types of information, or which gives access to particular types of controls, the station 102 may automatically configure its display to provide the user 108 with the information and controls that are needed to perform their job, while removing information that may be unnecessary or that the user 108 might not be authorized for.

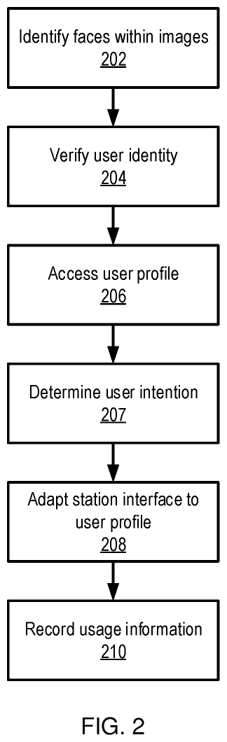

Referring now to FIG. 2, a method for using face information to customize a user experience is shown. Block 202 identifies faces within images. For example, these images may include frames of a video stream, or may include still images, taken by cameras 104, and may include location/identifier information. Using a facial recognition model, block 202 identifies people within the frame and records the associated features, including face image quality, a thumbnail, a camera identifier, a location, time information, and any other associated information. If the face image quality is higher than a threshold (e.g., providing a clear image of the person's face), then the information may be used to identify the person associated with the face image.

Using the user's facial recognition, block 206 accesses the user's profile, based on verification of the identity of the detected person. This profile may include previous visit information, preferences, ability information, permissions and authorizations, and other associated information. If the person is not identified, for example if there is no matching user profile, then block 206 may create a user profile, or may take any other appropriate action. In some cases, the profile may be associated with a group of people, for example friends, family, a class, or some other grouping.

To create a new user profile, block may take a photo of the user for face recognition. The photo may be retaken if it is not of sufficiently high quality for subsequent facial recognition purposes. The person 108 may also enter various information, such as their name, payment information, content preferences, etc., using an input interface at the station 102. A unique identifier may be generated for the new user profile, which may be stored with a feature representation of the face image, a thumbnail of the face image, and any additional profile information.

Block 207 may include a determination of the user's proximity and attention to determine whether the user intends to view or interact with the station 102. For example, block 207 may make use of the thumbnail of a person's face and various metadata, such as face landmarks, pose, age, gender, facial expression, gaze direction, etc. Face landmarks may help identify a frontal score and eye distance to determine which direction the person's face is pointing, while poses information may include yaw, roll, and pitch information to identify the person's body position. This information may be used to estimate a proximity and attention score for the person. Proximity helps determine which person or people in the frame are close to the station 102, while attention helps determine whether each person is engaged with the station 102.

For example, a proximity score may be calculated as a weighted sum of the frontal score and the eye distance. The weights of the frontal score and eye distance may be set to any appropriate value. The attention score may be calculated as a weighted sum of the yaw, roll, and pitch, with the weights for each being set as appropriate.

Block 208 adapts a station's interface in accordance with the user's profile. Block 208 may therefore change the information that is presented at the station 102, may change the manner in which the information is presented, may change an input interface, may provide augmentations for the hearing or vision impaired, or may take any other appropriate action. The proximity score for each user may be used to determine whether to adapt the interface for that user, for example with scores that are above a threshold being considered. In some cases, the station 102 may be limited in how many people it can be adapted to at once. In such a case, a number of people can be selected in accordance with proximity and attention, for example by excluding those visitors who are farther away or who are not paying attention to the station 102.

For example, block 208 may cause a station 102 to display a welcome message, triggered by the user's proximity and attention. This welcome message may be customized to the users, for example displaying their names and any preferred information. If the user was not recognized, block 208 may invite the person to create a profile. In the event that too many people are at the station 102 for each to be addressed individually, block 208 may cause the station 102 to provide a general address, or may provide more abbreviated customized information. If multiple members of a group that shares a profile stand at a station 102 at the same time, then block 208 may present the customized only once for the group.

In some cases, the stations 102 may be general purpose, with each station 102 being able to provide any information that the user is interested in. In some cases, one or more stations 102 may have a specific topic, being optimized to present a particular kind of content or to receive a particular type of input. In such a case, block 208 may assign each registered person 108 based on the preferences saved in their profile for a specific station 102. For example, some content may use particular display or audio capabilities. The person 108 can be directed to a specific station 102 that can provide them with their preferred content. If no preference is set, then a previous visit history may be used to help assign the user to a station 102. If no history information is available, then the person 108 may be assigned to a nearest station 102.

In some cases, the person 108 may first approach a station 102 that is not equipped to address their preferences. For example, the station 102 may lack certain user interface features, may be too small, may be inaccessible, or may otherwise be unsuitable for the user. In such cases, the person 108 may be directed to a different station 102, which is better suited for their preferences. The person 108 may be matched to a station 102 using any appropriate matching process.

As the user(s) interact with the station, block 102 may record and aggregate usage information. This information may include the station identifier, an identifier for the person 108, the proximity score, the attention score, profile information, visit history, etc. This information may furthermore be aggregated across multiple users 108 and across multiple stations 102, thereby providing information for later analysis. For example, this information can be used to determine which stations 102 are popular and the amount of time that users 108 spend at each station.

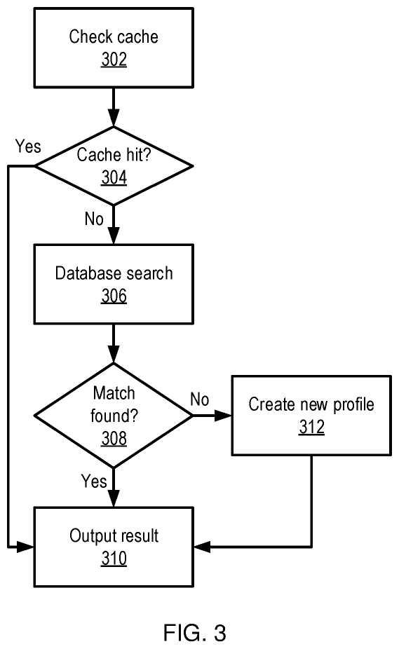

Referring now to FIG. 3, additional detail is shown for accessing the user profile in block 206. Block 302 checks a profile cache. For example, a least-recently-used caching policy may be used. Any appropriate cache size may be used, in accordance with available system resources, with an exemplary value of 10,000. Block 304 determines whether an incoming profile request hits the cache. If so, block 310 outputs the matched profile.

If the profile request does not hit any profile stored in the cache, then block 306 performs a search of a profile database. The profile database may be partitioned, to provide parallel linear searching. These partitions may be stored in local memory, and may be contiguously allocated to increase sequential access performance. This partitioning may be performed at any time, such as at system startup. Block 308 determines whether the incoming profile request is found in the database. If so, block 310 outputs the matched profile.

If the profile request does not match any profile in the database, then block 312 may create a new profile for the user, as described above. As new profile information is received, the new profile may be added to the partition having the lowest load, to maintain a uniform partition size.

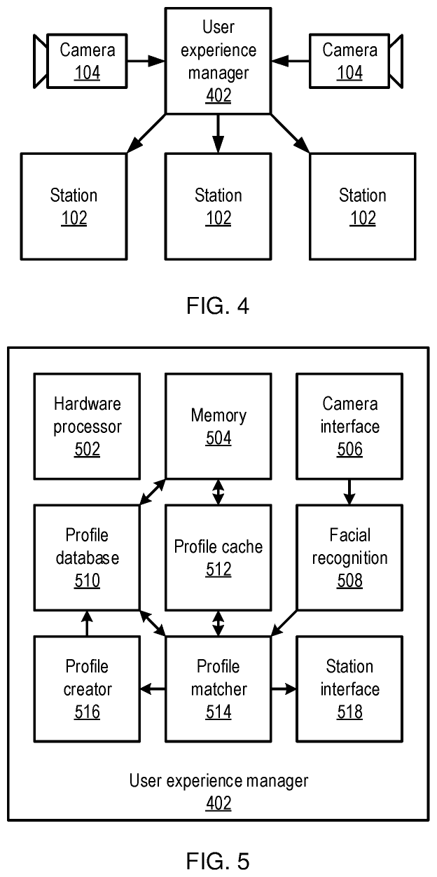

Referring now to FIG. 4, a diagram of the components of an experience management system is shown. As shown, one or more cameras 104 provide their video feeds to a user experience manager 402. The user experience manager 402 manages the identification of users, for example by identifying people 108 who are interacting with stations 102 using facial recognition, and finds profile information for the identified users by referring to a stored profile database.

The user experience manager 402 then sends control information to the stations 102 in accordance with the people 108 that are interacting with each respective station. The information sent by the user experience manager 402 may control the information that is presented at the station 102, including the content that is presented and the manner in which the content is presented.

Although the user experience manager 402 is shown as being a discrete system that interfaces with multiple different stations 102, it should be understood that the user experience manager 402 may also be hosted locally at the stations, with each station 102 having its own respective user experience manager 402. In such an embodiment, the user profile information may be shared between the user experience managers 402 at the respective stations 102, and the cameras 104 may each be associated with a particular station.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

Referring now to FIG. 5, additional detail is provided on the user experience manager 402. The user experience manager 402 includes a hardware processor 502 and a memory 504. The memory may include random access memory (RAM), a processor cache, and/or a solid state disk or hard disk drive. The user experience manager 402 may include one or more functional modules, which may be implemented as software that is stored in memory 504 and that is executed by hardware processor 502. One or more of the functional modules may be implemented as one or more discrete hardware components, for example in the form of application specific integrated chips or field programmable gate arrays.

A camera interface 504 receives video streams or still frames from one or more cameras 104. This interface may be a dedicated interface that receives information directly from the cameras 104 by any appropriate physical or wireless medium and protocol. Alternatively, the cameras 104 may be networked, with the cameras interface 504 including a network interface that receives the information from the cameras 104 by any appropriate wired or wireless communications medium and protocol. The camera information is processed by facial recognition 508, which provides facial features that can be used by a profile matcher 514 to identify a user's profile, based on matching with a face picture that is associated with the user's profile.

The profile matcher 514 receives facial feature information from facial recognition 508 and checks a profile cache 512 and/or a profile database 510 to identify a matching user profile. If no such match is found, then profile creator 516 may create a new profile for the user, and may store that new profile in the profile database 510.

The profile matcher 514 provides a matched profile to the station interface 518. The station interface 518 communicates with the stations 102 using any appropriate wired or wireless communications medium and protocol, providing instructions to the stations 102 as to how to present content to people 108 who are interacting with the stations 102.

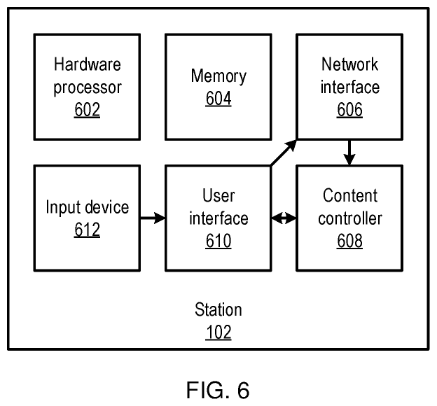

Referring now to FIG. 6, additional detail on the stations 102 is shown. The station 102 includes a hardware processor 602 and a memory 604. The memory may include random access memory (RAM), a processor cache, and/or a solid state disk or hard disk drive. The system 602 may include one or more functional modules, which may be implemented as software that is stored in memory 604 and that is executed by hardware processor 602. One or more of the functional modules may be implemented as one or more discrete hardware components, for example in the form of application specific integrated chips or field programmable gate arrays.

A network interface 606 may communicate with the user experience manager 402 by any appropriate wired or wireless communications medium and protocol. As noted above, in some embodiments the user experience manager 402 may be incorporated as part of the station 102 itself, in which case instructions from the user experience manager 402 may be handled by internal communications.

A content controller 608 uses the instructions from the user experience manager 402 to select content to present, and the manner in which the content is presented. The content controller 608 uses a user interface 610 to present the content. For example, the user interface 610 may include visual elements, audio elements, haptic elements, tactile elements, and any other appropriate manner of communicating information. An input device 612 may communicate with the user interface 610 to accept information from the user 108, for example accepting selections, controls, or data entry by the user 108. The user interface 610 may therefore provide information back to the user experience manager 402 via the network interface 606, for example to update the user's profile. The user's input may also be used to control other devices on a network, to select content for display, and any other appropriate action.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for controlling a user interface, comprising:
identifying a user at a station based on facial recognition of an image of the user's face in a video stream, to match a profile for the user;
determining at least one preference of the user for the display of content, based on the matched profile;
configuring content for the user in accordance with the at least one preference; and
displaying the configured content on a user interface of the station.

2. The computer-implemented method of claim 1, wherein configuring the content includes selecting information to be displayed.

3. The computer-implemented method of claim 1, wherein configuring the content includes selecting a visual format for information to be displayed.

4. The computer-implemented method of claim 3, wherein selecting the visual format includes adapting the visual format to the user's visual abilities, as indicated by the profile.

5. The computer-implemented method of claim 3, wherein selecting the visual format includes adapting the information in accordance with the user's auditory abilities, as indicated by the profile.

6. The computer-implemented method of claim 1, wherein identifying the user includes identifying a plurality of such users.

7. The computer-implemented method of claim 6, wherein identifying the plurality of users includes determining scores based on a pose and an attention of respective users within a visual field of a camera.

8. The computer-implemented method of claim 7, wherein identifying the plurality of users includes identifying a predetermined number of users having the highest scores.

9. The computer-implemented method of claim 6, wherein displaying the configured content includes displaying content that is configured based on multiple profiles at once.

10. The computer-implemented method of claim 6, wherein the plurality of users are matched to a single profile.

11. A system for controlling a user interface, comprising:
a user interface;
a hardware processor; and
a memory that stores a computer program product, which, when executed by the hardware processor, causes the hardware processor to:
identify a user at a station based on facial recognition of an image of the user's face in a video stream, to match a profile for the user;
determine at least one preference of the user for the display of content, based on the matched profile;
configure content for the user in accordance with the at least one preference; and
display the configured content on the user interface.

12. The system of claim 11, wherein the computer program product further causes the hardware processor to select information to be displayed.

13. The system of claim 11, wherein the computer program product further causes the hardware processor to select a visual format for information to be displayed.

14. The system of claim 13, wherein the computer program product further causes the hardware processor to adapt the visual format to the user's visual abilities, as indicated by the profile.

15. The system of claim 13, wherein the computer program product further causes the hardware processor to adapt the information in accordance with the user's auditory abilities, as indicated by the profile.

16. The system of claim 11, wherein the computer program product further causes the hardware processor to identify a plurality of such users.

17. The system of claim 16, wherein the computer program product further causes the hardware processor to determine scores based on a pose and an attention of respective users within a visual field of a camera.

18. The system of claim 17, wherein the computer program product further causes the hardware processor to identify a predetermined number of users having the highest scores.

19. The system of claim 16, wherein the computer program product further causes the hardware processor to display content that is configured based on multiple profiles at once.

20. The system of claim 16, wherein the plurality of users are matched to a single profile.
